(19) United States
(12) Patent Application Publication
(10) Pub. No.: US 2002/0152135 A1
(43) Pub. Date: Oct. 17, 2002

(54) System and method for e-commerce interface with controlled e-commerce interactions

(76) Inventors: Yishai Beeri, Jerusalem (IL); Itay Zandbank, Tikva (IL)

Correspondence Address: DR. D. GRAESER LTD., C/O THE POLKINGHORNS, 9003 FLORIN WAY, UPPER MARLBORO, MD, 20772, US

(21) Appl. No.: 09/810,396

(22) Filed: Mar. 19, 2001

Related U.S. Application Data
(63) Continuation-in-part of application No. 09/597,462, filed on Jun. 19, 2000.

(51) Int. Cl. G06F 17/60

(52) U.S. Cl. 705/27

(57) ABSTRACT

A system and a method for providing a unified, single, integrated interface for performing such e-commerce activities as purchasing products from different vendors, performing price comparison procedures, searching for products of interest and managing the purchase of different products from different vendors through e-commerce. The system and method have the advantage of providing these features in a unified interface, since mastery of this integrated interface by the user is sufficient for performing all of these activities. In addition, the system and method connect such e-commerce activities as searching for products of interest and purchasing these products, unlike background art e-commerce services.

This is a Continuation-in-Part Application of U.S. patent application No. 09/597,462, filed on Jun. 19, 2000, which is currently pending and which is incorporated by reference as if fully set forth herein.

### FIELD AND BACKGROUND OF THE INVENTION

The present invention relates to a system and a method for an e-commerce interface which provides controlled e-commerce interactions, and in particular, to such a system and method in which a third party is able to define at least one parameter according to which the user is able to perform e-commerce interactions through a single unified interface.

As the Internet grows, many Web sites are becoming connected and more corporations are trying to do business on the “Web”, by selling their products electronically, for example through a credit card. The area of electronic sales or Electronic Commerce (e-commerce), has been developing rapidly, as the Internet enables users to purchase products from vendors situated all over the world, at a time which is convenient for the user. In order to further attract users to visit their Web sites, and to cause these users to purchase products, vendors have attempted to increase the east of purchasing products, with such innovations as the “one-click” shopping method of Amazon.com, and so forth.

The drawback of such attempted innovations is that each vendor provides a different interface, and a different method for purchasing products. The user can easily become confused, as one vendor may require the user to first register before purchasing a product, another vendor may enable the user to enter credit card information and purchase information about the product at different stages and/or in a different order for the purchasing process, while still another vendor may simply have a poorly designed Web site, such that the user cannot easily select and purchase products.

In addition, even if the user is able to maneuver through these different types of Web sites and purchase mechanisms, the user may still have difficulty selecting the vendor of interest. For example, the user may not know which vendor sells a particular type of product. The user may also wish to purchase a specific product, such as a particular book, which may not be available at all of these different vendors. The user may have other desires and/or constraints, such as a particular maximum purchase price and/or shipping time for the product.

Currently, the user may use certain searching services in an attempt to obtain information about these different features of the purchasing process. However, the searching services are not directly connected to the purchasing process, such that the user must still go to the Web site of the selected vendor and purchase the product. Furthermore, these searching services do not offer price comparison and other assistance for a collection of different products, which may be most effectively purchased from a plurality of different vendors. Thus, although the searching services may be useful for a single product, they have many drawbacks for users who wish to purchase entire groups or collections of products.

In addition, these different e-commerce services currently require the user to have access to a credit card for payment, such that users who do not have such access are excluded from e-commerce interactions. In particular, one such group of individuals who are technologically literate and interested in shopping “on-line” through e-commerce is minor children. These minor children, particular those who are 12-18 years of age and hence may be defined as “teen-agers”, are often very interested in e-commerce. However, their parents may not wish to allow them completely free access to their credit cards, for example from a fear that the minor child would attempt to pay for and view sexually explicit material with the credit card. These parents might feel more comfortable being able to restrict the actions of the minor children through e-commerce, for example by being able to prevent minor children from purchasing products through pornographic Web sites, and/or by being able to set a monetary limit to the amount of purchases which may be made.

Various solutions have been proposed which attempt to overcome this problem, by providing a credit card substitute for use by minor children and/or other individuals who do not have access to credit cards. For example, “Internet Cash” (www.internetcash.com as of Sep. 25, 2000) provides a service in which cards are purchased for a certain, specific denomination. The cards may be purchased through a kiosk or retail store, for example. The user may then use the amount of money specified in the denomination of the card for purchases through the Internet. Unfortunately, in a drawback shared by other e-commerce monetary substitutes such as “CyberMoola” (www.cybermoola.com as of Sep. 25, 2000), the user cannot purchase products at any vendor or through any Web site on the Internet, but instead is limited to those vendors and/or Web sites which are registered with the provider of the substitute credit card. Clearly, the inability to purchase products through any e-commerce vendor and/or Web site is a significant disadvantage for these attempted solutions.

In addition, these attempted solutions do not solve the particular problem of control over purchases of a user by a third party, as for example with minor children, whose parents wish to be able to exert at least partial control over the nature of these purchases. Therefore, the credit card substitutes do not give the minor child the ability to purchase products at a variety of different merchants of which the parents may approve, yet still may give the minor child too much freedom to purchase products which the parents may consider to be inappropriate.

A more useful solution would provide a unified, single interface for purchasing products from vendors through e-commerce, which would be controllable by a third party, such as the parents of the minor child in the above example. This interface would also connect the searching and shopping assistance features of the searching services, with features and support for purchasing products from a plurality of vendors. In addition, preferably such a solution would enable the user to receive guidance and search information for purchasing a plurality of products from a single vendor according to criteria such as price, or even to purchase such a plurality of products from a plurality of vendors. Thus, such a solution would benefit both the third party who wished to control the purchases of the user, and also the user, who could have freedom to perform purchases within certain parameters from a variety of e-commerce vendors. Unfortunately, such a solution is not currently available.

Therefore, there is an unmet need for, and it would be highly useful to have, a system and a method for providing a unified, single interface for supporting e-commerce activities, which would include searching for one or more vendors according to one or more criteria, as well as purchasing such products from one or more vendors, in which a third party could control the purchases of the user by setting at least one parameter according to which such purchases are performed.

### SUMMARY OF THE INVENTION

The present invention is of a system and a method for controlling the purchases of a user by a third party, by determining at least one parameter according to which the purchases can be made by the third party. Such a parameter may optionally include, but is not limited to, any one or more of the following: providing a list of Web sites and/or vendors from which purchases may not be made; providing such a list from which purchases may only be made; restricting the amount of total purchases in a time period and/or at a single time; and, with an optional filtering mechanism for filtering the content of the Web sites, providing an “alarm” service if a Web site appears to have restricted content of which the third party may not approve. This control is provided while still enabling the user to otherwise have freedom to perform purchases with the credit card of the third party, but without being able to gain access to the credit card information itself, by providing a unified, single, integrated interface.

The single unified interface of the present invention also performs such e-commerce activities as purchasing products from different vendors, performing price comparison procedures, searching for products of interest and managing the purchase of different products from different vendors through e-commerce. The present invention has the advantage of providing these features in a unified interface, since mastery of this integrated interface by the user is sufficient for performing all of these activities. In addition, the present invention connects such e-commerce activities as searching for products of interest and purchasing these products, unlike background art e-commerce services.

According to the present invention, there is provided a method for controlling an e-commerce activity of a user to a vendor through a network by a third party, the method comprising the steps of: (a) providing a single unified interface for interacting with the user and providing at least one rule by the third party for controlling the plurality of e-commerce activities; (b) selecting the e-commerce activity by the user; (c) retrieving information from the vendor by the single unified interface through the network about the e-commerce activity to form retrieved information; (d) selecting a product by the user according to the retrieved information; (e) comparing at least one characteristic of the e-commerce activity to the at least one rule; and (f) if the at least one characteristic of the first e-commerce activity complies with the at least one rule, purchasing the product by the user through the single unified interface.

Hereinafter, the term “network” refers to a connection between any two or more computational devices which permits the transmission of data, such as the Internet for example.

Hereinafter, the term “computational device” includes, but is not limited to, personal computers (PC) having an operating system such as DOS, Windows™, OS/2™ or Linux; Macintosh™ computers; computers having JAVA™-OS as the operating system; graphical workstations such as the computers of Sun Microsystems™ and Silicon Graphics™, and other computers having some version of the UNIX operating system such as AIX™ or SOLARIS™ of Sun Microsystems™; or any other known and available operating system, or any device, including but not limited to: laptops, hand-held computers, PDA (personal data assistant) devices, cellular telephones, any type of WAP (wireless application protocol) enabled device, wearable computers of any sort, which can be connected to a network as previously defined and which has an operating system. Hereinafter, the term “Windows™” includes but is not limited to Windows95™, Windows NT™, Windows98™, Windows CE™, Windows2000™, and any upgraded versions of these operating systems by Microsoft Corp. (USA).

For the present invention, a software application could be written in substantially any suitable programming language, which could easily be selected by one of ordinary skill in the art. The programming language chosen should be compatible with the computational device according to which the software application is executed. Examples of suitable programming languages include, but are not limited to, C, C++ and Java.

In addition, the present invention could be implemented as software, firmware or hardware, or as a combination thereof. For any of these implementations, the functional steps performed by the method could be described as a plurality of instructions performed by a data processor.

Hereinafter, the term “Web browser” refers to any software program which can display text, graphics, or both, from Web pages on World Wide Web sites. Hereinafter, the term “Web server” refers to a server capable of transmitting a Web page to the Web browser upon request.

Hereinafter, the term “Web page” refers to any document written in a mark-up language including, but not limited to, HTML (hypertext mark-up language) or VRML (virtual reality modeling language), dynamic HTML, XML (extensible mark-up language) or XSL (XML styling language), or related computer languages thereof, as well as to any collection of such documents reachable through one specific Internet address or at one specific World Wide Web site, or any document obtainable through a particular URL (Uniform Resource Locator). Hereinafter, the term “Web site” refers to at least one Web page, and preferably a plurality of Web pages, virtually connected to form a coherent group.

Hereinafter, the phrase “display a Web page” includes all actions necessary to render at least a portion of the information on the Web page available to the computer user. As such, the phrase includes, but is not limited to, the static visual display of static graphical information, the audible production of audio information, the animated visual display of animation and the visual display of video stream data.

Hereinafter the word “product” includes both physical products and services (tangible and intangible products), as well as ideas and concepts.

### BRIEF DESCRIPTION OF THE DRAWINGS

The invention is herein described, by way of example only, with reference to the accompanying drawings, wherein:

FIG. 1. is an exemplary screen display of the initial window of the unified, single interface of the present invention;

FIG. 2 shows an example of an initial Web page of the selected vendor;

FIG. 3 shows an exemplary product Web page of the selected vendor;

FIG. 4 shows an example of a shopping cart window according to the present invention;

FIG. 5 shows an exemplary credit card window according to the present invention;

FIG. 6 shows an exemplary shipping information window according to the present invention;

FIG. 7 shows an exemplary checkout window for completing the purchase according to the present invention;

FIG. 8 shows an exemplary price comparison feature with the shopping cart window according to the present invention;

FIG. 9 shows an exemplary search window according to the present invention;

FIG. 10 shows an exemplary search results window according to the present invention;

FIG. 11 shows a product Web page of the vendor;

FIG. 12 shows an exemplary price comparison window according to the present invention;

FIG. 13 is a schematic block diagram of an exemplary system according to the present invention;

FIG. 14 is an exemplary billing entry window according to the present invention; and

FIG. 15 is a flowchart of an exemplary method according to the present invention for performing the purchase with the account which is at least partially controlled by the third party.

### DESCRIPTION OF THE PREFERRED EMBODIMENTS

The present invention is of a system and a method for controlling the purchases of a user by a third party, by determining at least one parameter according to which the purchases can be made by the third party. Such a parameter may optionally include, but is not limited to, any one or more of the following: providing a list of Web sites and/or vendors from which purchases may not be made; providing such a list from which purchases may only be made; restricting the amount of total purchases in a time period and/or at a single time; and, with an optional filtering mechanism for filtering the content of the Web sites, providing an “alarm” service if a Web site appears to have restricted content of which the third party may not approve. This control is provided while still enabling the user to otherwise have freedom to perform purchases with the credit card of the third party, but without being able to gain access to the credit card information itself, by providing a unified, single, integrated interface.

The single unified interface of the present invention also performs such e-commerce activities as purchasing products from different vendors, performing price comparison procedures, searching for products of interest and managing the purchase of different products from different vendors through e-commerce. The present invention has the advantage of providing these features in a unified interface, since the present invention is able to communicate with different vendors in order to obtain the requested information. This information is then provided to the user through the single interface, such that the user is able to easily search for products, perform price comparisons and purchase products through a single set of operations. Thus, the present invention overcomes the disadvantages of background art e-commerce services, which do not connect different services such as product searches and product purchases, and which do not provide the single, integrated interface.

In addition, the single, unified interface of the present invention has the advantage of more easily providing control by the third party, while still enabling the user to perform purchases at multiple times and/or Web sites/vendors. This interface also provides an automated purchasing capability at a single source, without which such a system and/or method would not be useful, as control by the third party could not be provided. In addition, the present invention enables the credit card account of the third party to be used while protecting the credit card details from the user, yet without requiring the vendor and/or owner of the Web site to become involved in the purchase, or even to be aware of the identity of the user making the purchase. In other words, only the identity of the third party would be required, in order to complete the credit card purchase. Thus, only the present invention solves the previously described problems with background art attempted solutions for enabling users who do not have access to credit cards, such as minor children, to perform purchases through e-commerce “on-line”.

The principles and operation of the present invention may be better understood with reference to the drawings and the accompanying description.

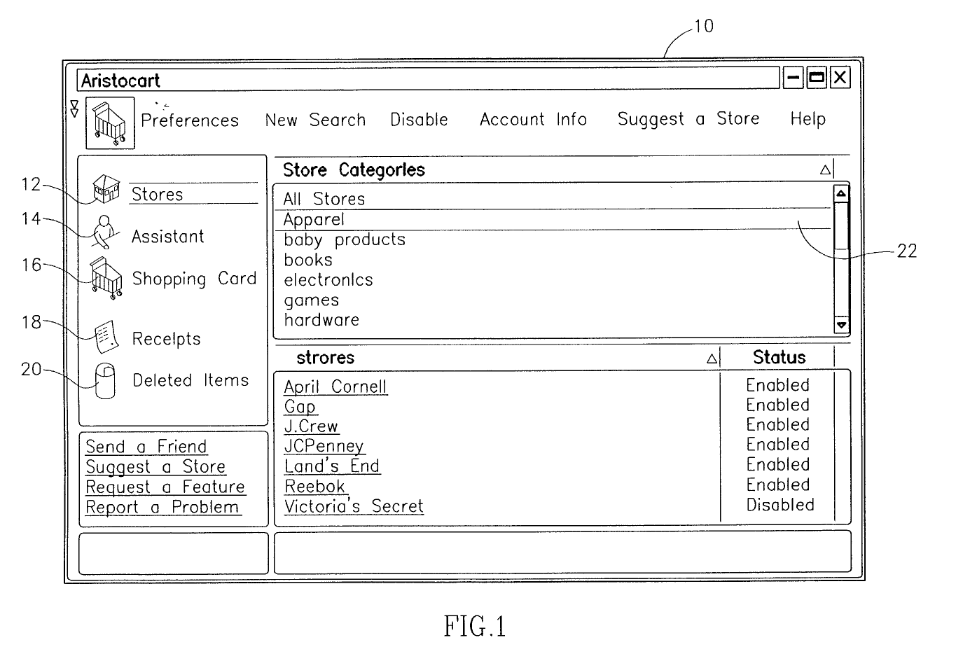

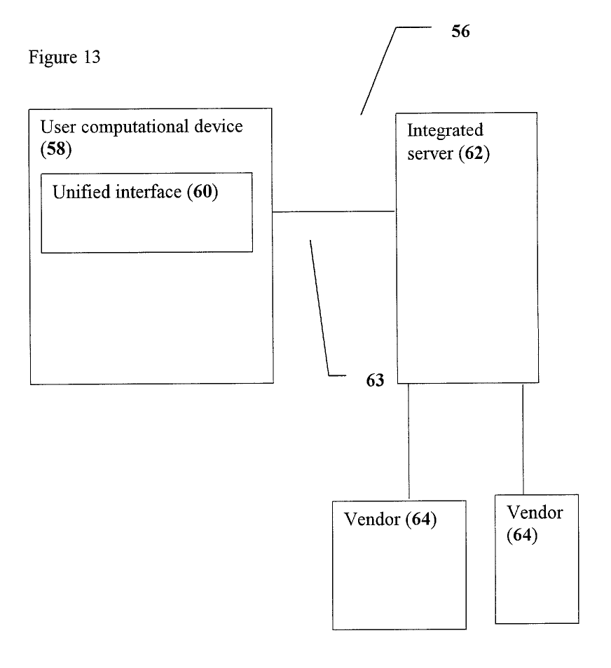

Referring now to the drawings, FIGS. 1-12 show exemplary screen displays for operating the client according to the present invention, in order to perform one or more e-commerce activities through the unified, single interface. These exemplary screen displays show the unified, single interface, as provided to the user through the GUI (graphical user interface) of the computational device of the user. An exemplary system for supporting the operation of the unified, single interface is shown in FIG. 13, it being understood that the configuration of the system is intended as only one example of many different possible such configurations.

As FIGS. 1-13 demonstrate, the importance of the unified, single interface is that such an interface provides a comfortable, simple interaction with the user for shopping and other e-commerce activities. The unified, single interface is a buffer between the user and the many different Web sites of different vendors, in that the interface enables the user to perform many different e-commerce activities, without being required to adjust such activities to the different Web site configurations and purchase procedures of the vendors. Instead, the purchase procedures and other mechanisms of the vendors are adjusted in order to conform with the structure of the unified, single interface. Thus, once the user is comfortable with the operation of the interface of the present invention, all further activities are adjusted to this known interface, such that the user is not required to learn how to interact with different vendors.

The interface itself could be any type of user interface, preferably as some type of GUI (graphical user interface) to the integrated server of the present invention, as shown for example in FIG. 13. The user interface could optionally and preferably be implemented as a client software application which is integrated into, or otherwise in communication with, a Web browser.

The description of the process which is shown in FIGS. 1-12 starts from the beginning, as the user performs the first interactions with the unified, single interface, and continues through various types of e-commerce activities, including purchasing products, entering credit card and shipping information, searching for products of interest, and receiving price comparisons.

At the beginning of the process, the user first selects the type of interaction to be performed. FIG. 1 is an exemplary screen display of the initial window of the unified, single interface of the present invention. As shown, the user views an initial display 10, and may optionally select to choose a category of stores 12; receive assistance such as searches from an assistance icon 14; purchase products and/or view other information about products to be purchased by selecting a shopping cart icon 16; view information about previously purchased products from a receipts icon 18; and optionally delete information which is not of interest through a delete icon 20.

As shown in this exemplary initial window 10, the user has chosen to select a category of stores. Category information is displayed in a category portion 22 at the right of initial window 10. The user has further chosen apparel, and a list of different vendors which sell apparel is also shown. As shown, the user has selected the vendor “J. Crew™”.

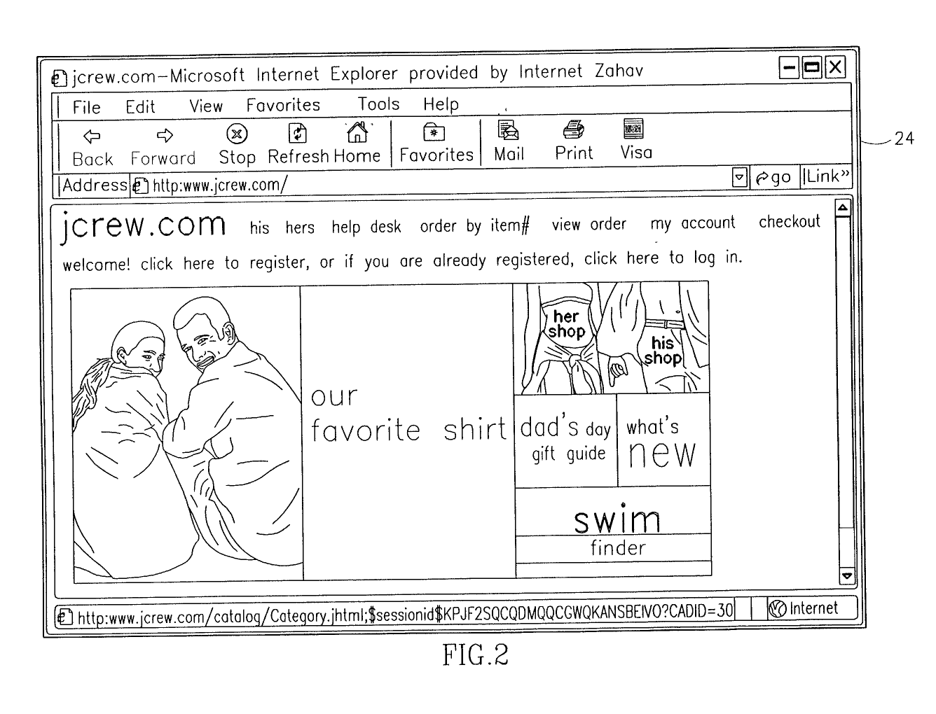

By selecting this vendor, the Web browser of the user becomes activated, and if the computational device of the user is not already connected to the Internet or other network, such a connection is optionally and preferably automatically initiated. In FIG. 2, an initial Web page 24 of the selected vendor is shown, as displayed through the Web browser which is operated by the computational device of the user. The user may now examine Web page 24 and/or other Web pages of the selected vendor, in a process which may optionally be displayed separately from initial window 10 of the unified, single interface, or even separately from any other such window.

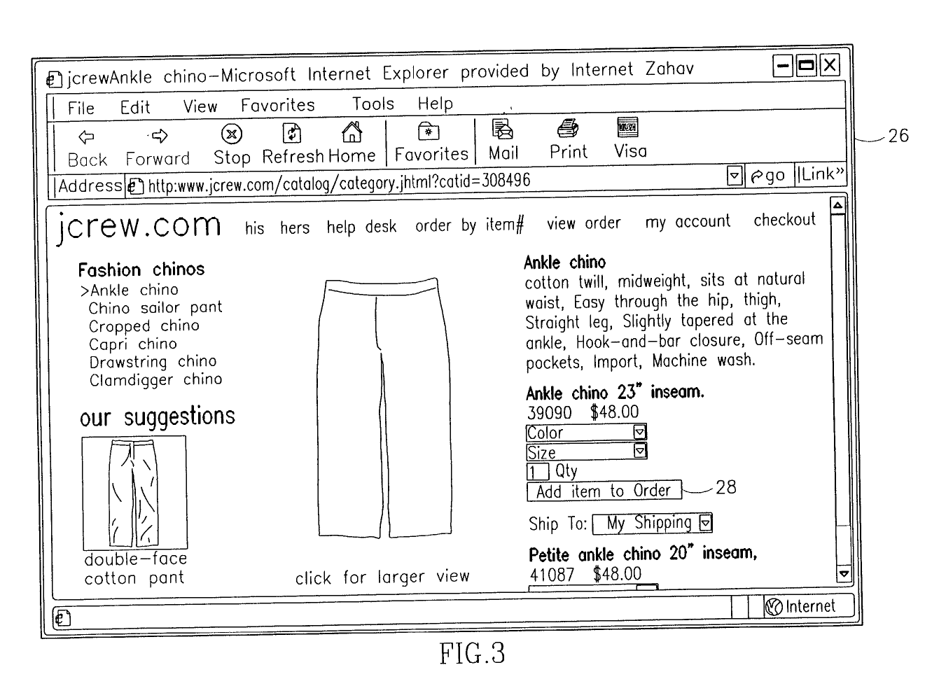

In FIG. 3, an exemplary product Web page 26 of the selected vendor is shown, which displays information about a product of interest. In this example, product Web page 26 features a purchase icon 28, for purchasing the product. Alternatively, the vendor may choose to display such a purchase icon 28 on a separate Web page.

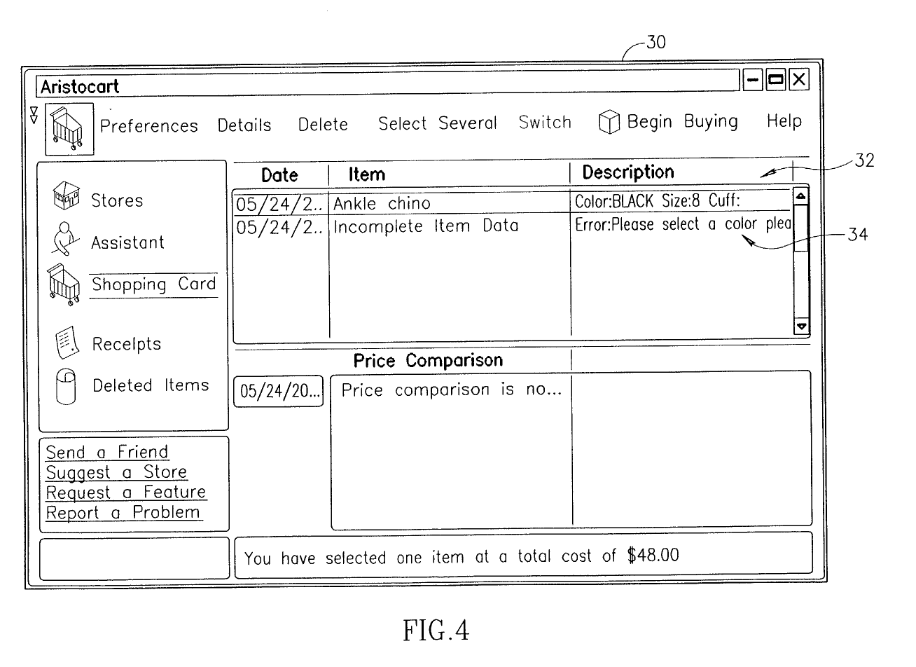

Once the user has selected purchase icon 28, the request to purchase the product is detected by the single, unified interface of the present invention. A new window for purchasing the product, which is a shopping cart window 30, is displayed, an example of which is shown in FIG. 4. Shopping cart window 30 could also optionally have been accessed directly from shopping cart icon 16 of FIG. 1. Shopping cart window 30 displays information, such as the name of the product, preferably with a brief product description in a first item description 32. Optionally and more preferably, any type of error message may also be displayed if the purchasing process cannot continue and/or if another type of error has arisen, as shown in a second item description 34. The cost and other information may optionally be displayed at the bottom of shopping cart window 30.

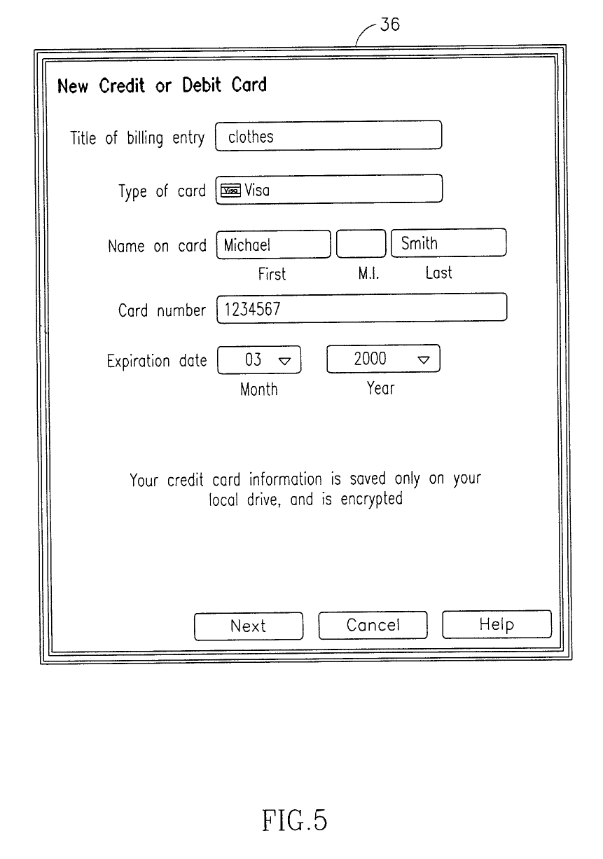

Now the user preferably needs to enter credit card and/or shipping information, if such information has not been previously provided by the user. FIG. 5 shows an exemplary credit card window 36, for entering such credit card information as the credit card number and issuing company, and the name of the credit card holder, for example. Preferably, this information is stored on a local storage medium of the computational device of the user, more preferably in an encrypted or other secure format, in order to provide security for such information.

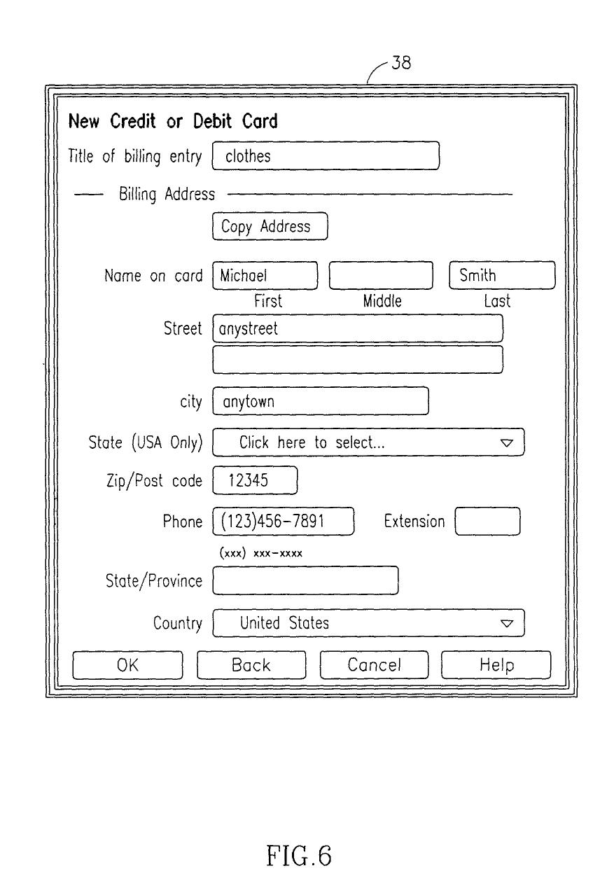

If the user has not already entered shipping information, such as the name and address of the individual to which the product is to be shipped, such information may optionally be provided through a shipping window 38, as shown in FIG. 6. If the user has already entered credit card and/or shipping information, such information is optionally and preferably retrieved from storage, more preferably from local storage on the storage medium of the user computational device.

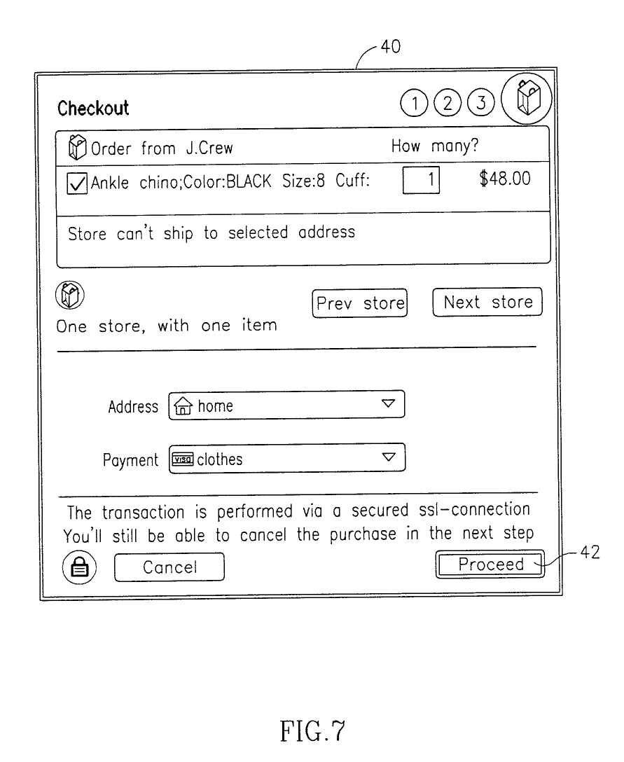

The user then optionally and preferably determines whether the purchase should be made, through a checkout window 40, an example of which is shown in FIG. 7. Checkout window 40 preferably includes a description of the vendor, and of the product or products to be purchased, optionally with product information such as price and availability. A keyword or other brief description of the credit card and shipping information is also preferably provided. In addition, if any errors have been encountered during the purchasing process, such as whether the vendor in question is able to ship to a particular address, this information is also preferably displayed. In addition, optionally and more preferably, the user is able to select various types of services which are provided by the vendor through checkout window 40, such as gift wrapping, special user accounts with the vendor, special delivery options, and so forth. If the user is satisfied with the purchase, and/or if no errors have been encountered, then the user may optionally select a proceed icon 42 to complete the purchase process.

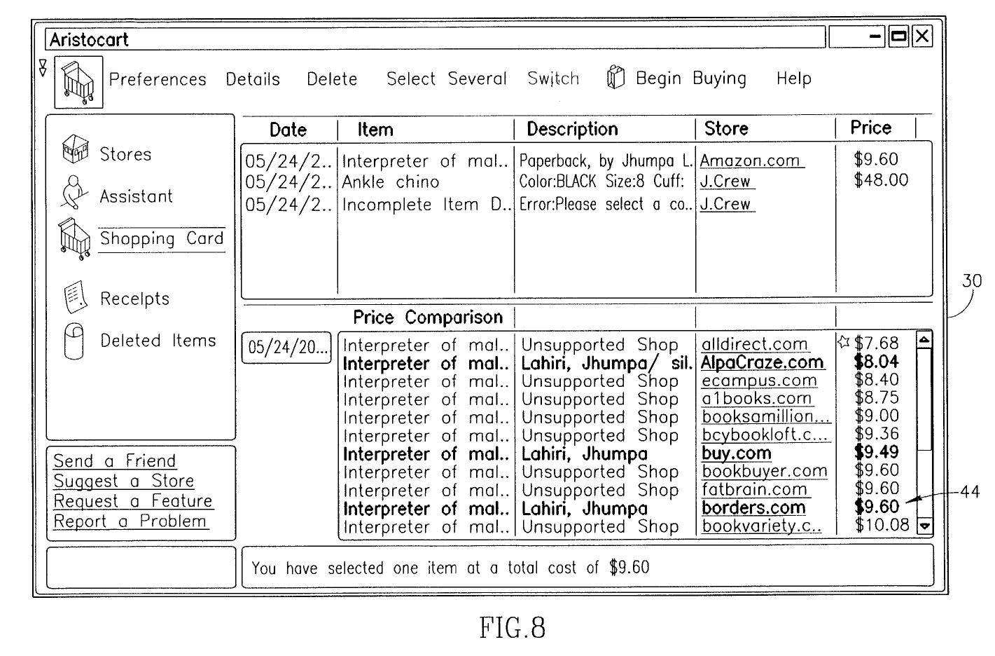

FIG. 8 shows shopping cart window 30 with an example of an optional but preferred feature of the present invention, which is a price comparison 44. In this example, the user has decided to purchase a particular book, in this case selected from the book vendor Amazon.com™. However, the user may also wish to know if the same book could be purchased less expensively from a different vendor. Price comparison 44 searches through Web sites of different vendors with the information about the book, for the purpose of performing the price comparison process. As shown in FIG. 8, a number of different vendors sell the book of interest. The name of each vendor is shown in price comparison 44, along with the price of the book. A red star is shown next to the name of the first vendor, which is offering the book at the same price or a lower price than the currently selected vendor. The user has the option to select this new vendor, and to purchase the product from that vendor. Thus, the price comparison process is preferably automatically performed.

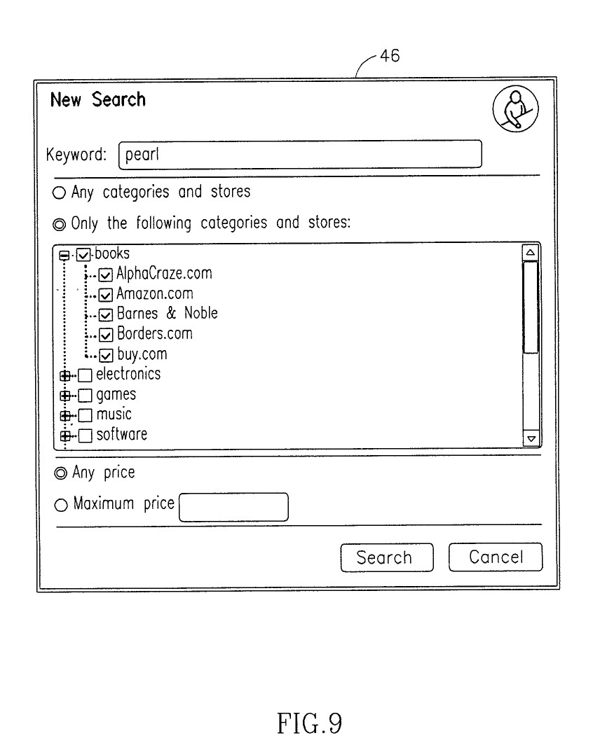

Another optional but preferred feature of the present invention is shown in FIG. 9, which is a search window 46, for performing a search for a particular product. Search window 46 enables the user to enter one or more keywords describing a product, such as the word “pearl”. Since this exemplary keyword could refer to a number of different types of products, the user may optionally select one or more categories, or even specific vendor(s) within each category, in order to focus the search. Optionally and more preferably, the user may also combine the search with the price comparison feature, by specifying a maximum price.

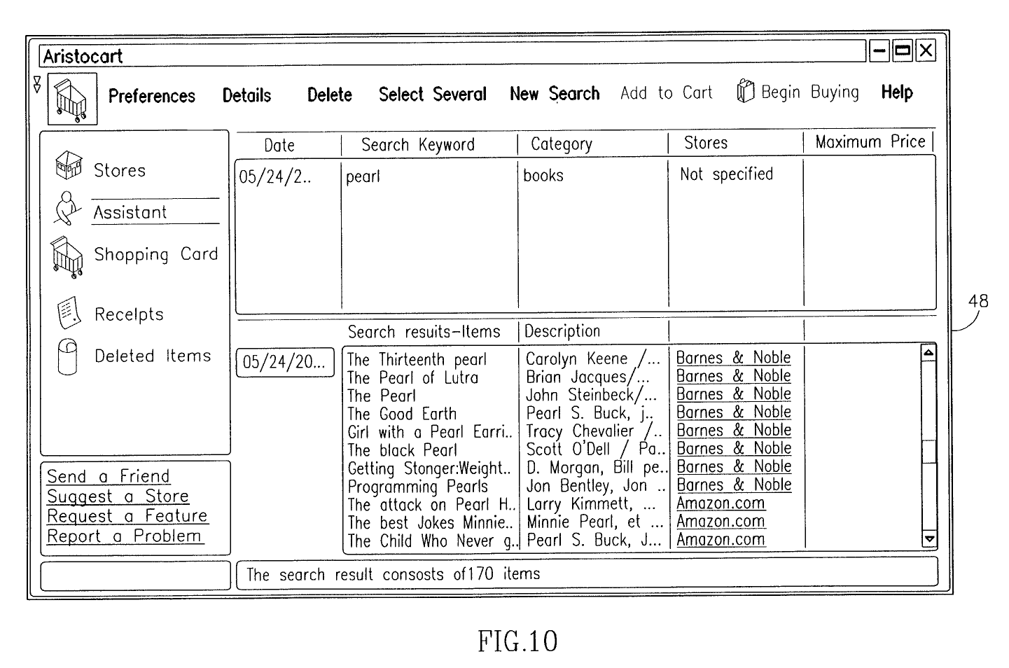

FIG. 10 shows a search results window 48, which may also optionally be accessed directly through assistance icon 14. Search results window 48 preferably includes a description of the search terms, such as the keyword(s) used; the category or categories of stores to which the search was limited, if any; and the specific store(s) to which the search was limited, again if any. In addition, the search results are also shown, with a list of each item, in this case titles of books; a brief description of the item, such as the author of the book; and the name of the vendor which is selling the book.

In this example, the keyword “pearl” has been found in the title of books, as well as part of the name of the author. The user may optionally perform a narrower search, for example with one or more additional and/or different keywords. Alternatively, the user may select an item which is of interest, by selecting the name of the vendor next to the description of the item.

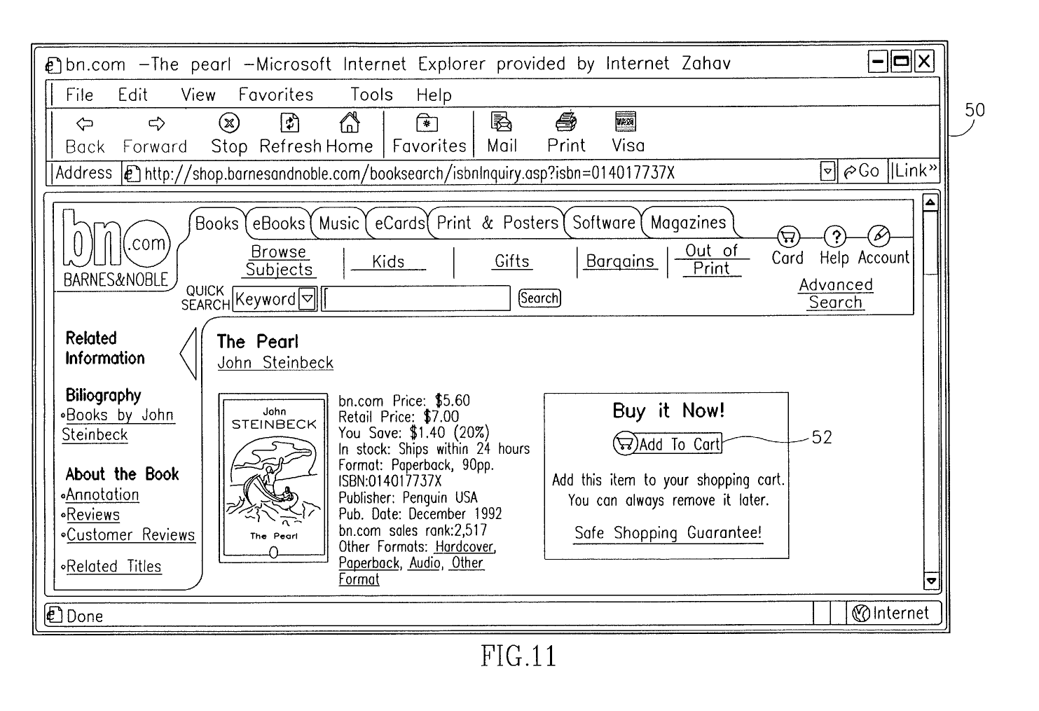

Selecting such a vendor name again activates the Web browser which is being operated by the computational device of the user, and causes the Web browser to display a Web page 50 of the vendor, an example of which is shown in FIG. 11. Web page 50 is now preferably a product Web page as shown, which includes a description of the particular product of interest to the user. The requisite information which is required to cause such a product Web page to be shown is preferably sent through the system of the present invention to the Web site of the vendor, as described in greater detail with regard to FIG. 13 below. If the user decides to purchase the product, then the user selects the requisite purchase icon 52 from Web page 50.

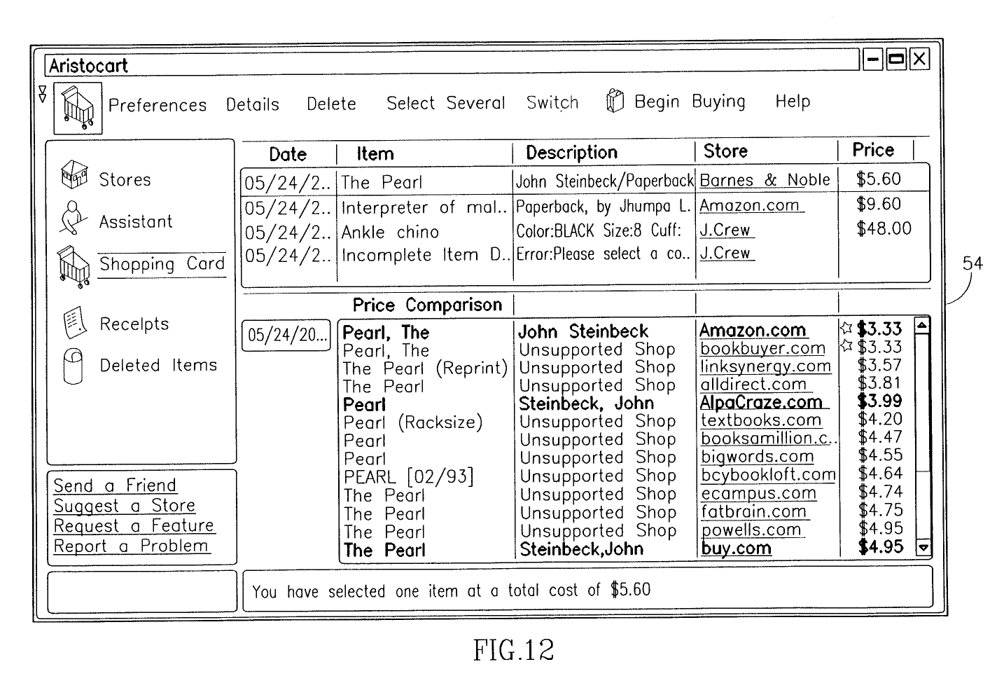

Again, optionally and more preferably, the price comparison process is performed as previously described, and the results are displayed in a price comparison window 54, as shown in FIG. 12. Optionally and preferably, the user can “drag” one of the items found during the search from the displayed search results to the shopping cart, in order to receive the price of the item. The act of “dragging” the item results in its inclusion in the shopping cart, such that substantially any other process of selection which causes the item to become associated with the shopping cart could be substituted thereof.

According to optional but preferred features of the present invention, preferably the user is able to see the history of purchases, determine the status of pending transactions, and so forth, through an accounts window of the interface (not shown), which shows information related to the account of the user at each vendor.

According to other preferred features of the present invention, previously performed purchases may be repeated. For example, if the user has a typical basket of groceries to be purchased through a vendor as an e-commerce transaction, the user may optionally and more preferably repeat such a purchase through a “drag and drop” or other selection mechanism. The remainder of the purchase process is then most preferably performed automatically.

According to still other preferred features of the present invention, the user is able to chat with a sales representative or other customer support personnel of the vendor, through a chat feature. For example, this feature could be used if the user needed assistance to select a particular product.

FIG. 13 is a schematic block diagram of an exemplary system according to the present invention. It is understood that this configuration is only one illustrative configuration for supporting the operation of the single, unified interface of the present invention, as described in FIGS. 1-12; and

that many different such configurations could be used.

As shown, a system 56 includes a user computational device 58 for interacting with the user (not shown). User computational device 58 operates a single unified interface 60, the functions of which are described above. User computational device 58 is also connected to a network 63, for communicating with an integrated server 62.

Integrated server 62 receives requests for performing e-commerce activities from single unified interface 60, and then contacts a plurality of vendors 64. Each vendor 64 is actually a server, for providing the Web page(s)/Web site of the vendor, and for performing the e-commerce activities of the vendor. Typically, vendor 64 communicates with HTTP commands and data. Integrated server 62 is able to receive such HTTP commands and data, and to parse this information, in order to understand the communication from vendor 64. Integrated server 62 then sends the parsed information to single unified interface 60, for display to the user.

Optionally and preferably, single unified interface 60 communicates indirectly with integrated server 62, for example through the server of a third party (not shown). One example of such a third party server is the server of a wireless service provider. The third party server is optionally more than a mere pipe, but instead may add information and/or support for the transaction. For example, the server of a wireless service provider may store user information such as the shipping address and credit card information of the user, which may not be stored on the wireless device of the user. This server would then provide the information to integrated server 62 in order for the purchase to be performed.

According to preferred embodiments of the present invention, the single unified interface may also optionally and preferably be used in order to provide the opportunity for controlled e-commerce to the user, such that at least one parameter of e-commerce activities by the user through the single unified interface is controlled by a third party. As previously described, only the present invention is able to provide such global control by a third party, while simultaneously affording otherwise unlimited freedom to the user. The single unified interface enables the user to perform the purchases in a transparent manner, without necessarily being aware of the control imposed by the third party.

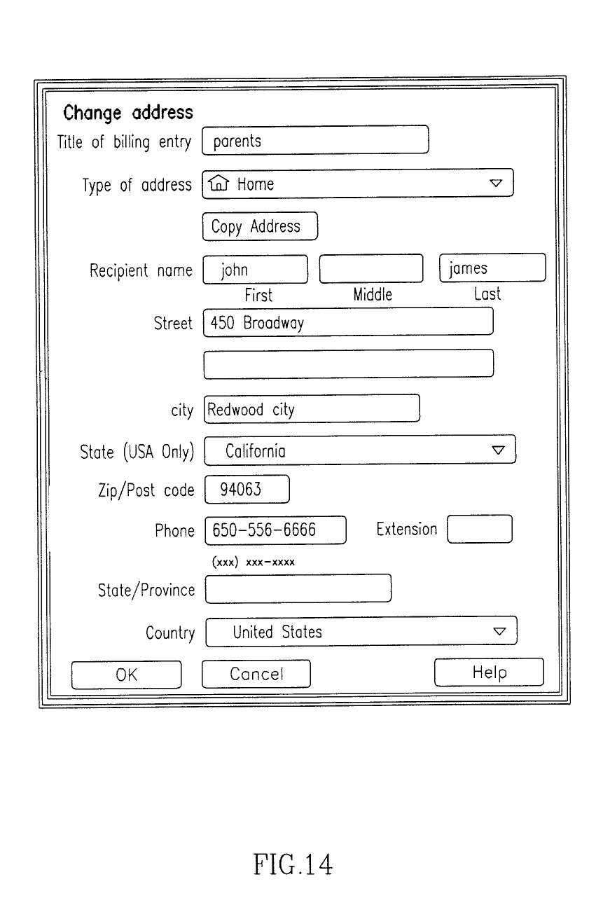

Preferably, the user is able to perform purchases through a particular “billing entry”, for which information may optionally be displayed and/or changed in a billing entry window, shown as an exemplary screenshot of the GUI in FIG. 14. In addition, information about the account of each user may optionally be displayed in an accounts window. As previously described, the accounts window of the interface shows information related to the account of the user, optionally at each vendor, but alternatively at a plurality of vendors, or even at all vendors.

In this preferred embodiment of the accounts window, the user receives an account with at least one parameter determined by the third party, for providing at least partial control over the purchases of the user by the third party. In order for such an account to be created, the following information is preferably specified: billing entry information (such as the name of the user, for example); at least one rule for determining the at least one parameter; and the credit card account according to which the purchases should be billed. More preferably the at least one rule is actually a predefined rule set, containing a plurality of rules, which most preferably the third party is then able to edit and/or modify. The billing entry information most preferably contains the name of the user, who is allowed to perform purchases with the account, and the name of the third party “owner”, who controls the account.

Optionally and more preferably, the rule set includes a plurality of rules, which as previously described, can most preferably be edited and/or modified by the third party. The type of control imposed by such rules may optionally vary. For example, certain rule sets may permit a general freedom to the user, with certain exceptions, while other rule sets may require manual confirmation of each purchase by the third party. Such manual confirmation is more preferably performed through an e-mail message to the third party, who would then send a “reply” e-mail message to confirm. Most preferably, such a step of confirmation is performed by the third party before the request for purchasing the product is sent to the vendor, such that the vendor only receives the request for purchase after the third party has confirmed the purchase, but otherwise does not receive any information about the purchase.

The validation of the purchase with regard to other types of rules also needs to be performed. At the very least, validation is performed before the purchase request is sent to the vendor for actually purchasing the product. Preferably, such validation is performed at two separate points in the purchase process. The first such point occurs once the user has finished entering information for performing the purchase, but before the purchase information is sent to the vendor in order to determine final price and so forth. The second such point occurs after the vendor has sent information concerning the final price and other characteristics of the purchase, but before the purchase has been completed with the vendor.

Examples of the rules which may optionally be invoked include, but are not limited to, enabling the user to only perform purchases at a list of permitted vendors, or alternatively generally enabling the user to perform such purchases except at vendors on a list of forbidden vendors; limiting a single purchase at any particular vendor to a certain amount of money; limiting the amount for any single item to a certain amount of money; limiting the total amount of money spent over a period of time, for example over one day, one week, one month and so forth; permitting or forbidding “carry over” if any limit is not exceeded; and limiting the shipping address for receiving the products to a particular address, or alternatively to one address of a list of addresses. Also optionally, the user may be forbidden from altering any of the shipping addresses, for example in order to prevent the user from having any purchased product shipped to an address which is not on the list.

With regard to manual confirmation by the third party, optionally and most preferably, manual confirmation from the third party can always be required, or could only be required in certain situations (for example, if one or more rules of the set of rules has been broken). Also optionally and most preferably, the present invention includes the feature of generating regular reports for the third party, concerning the activities of the user.

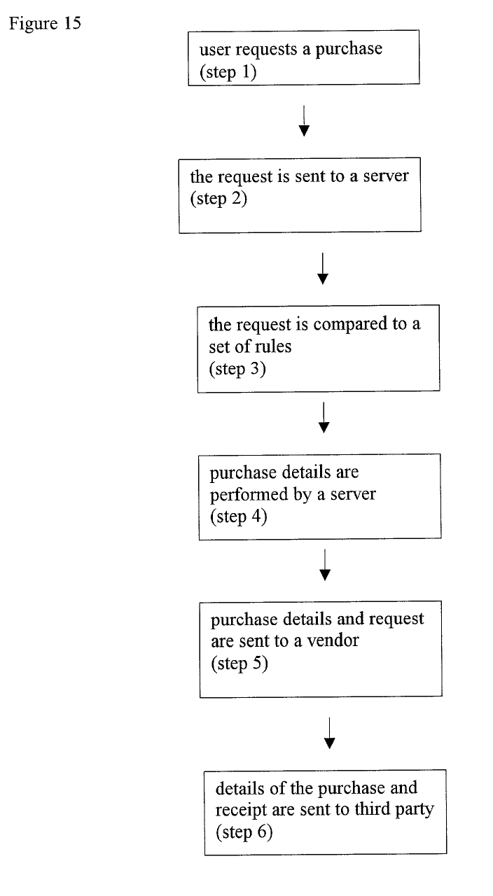

FIG. 15 is a flowchart of an exemplary method according to the present invention for performing the purchase with the account which is at least partially controlled by the third party. In step 1, the user requests a purchase through the single unified interface of the present invention. In step 2, the request is optionally and preferably sent to a server. This server is optionally the same as the server of FIG. 13, or alternatively may be a different server.

In step 3, the request is compared to the set of rules for validation. Alternatively, this step could optionally be performed on the same computational device which is providing the single unified interface to the user. In any case, if the purchase is valid, in step 4, the purchase details are performed by a server.

In step 5, the purchase details and request are sent to the vendor, thereby completing the performance of the purchase. This step may optionally be divided into two parts, in which a first stage includes confirmation of the details of the purchase, such as the price for example, from the vendor, and the second stage includes actual performance of the purchase, for example by sending the relevant credit card details to the vendor. Optionally and more preferably, the details of the purchase may be compared to the set of rules, by the server and/or by the computational device which is providing the single unified interface to the user, between the first and second stages, or alternatively at any time in the purchase process before actually triggering the purchase with the vendor.

In step 6, the details of the purchase and a receipt are preferably sent to the third party, for example by e-mail message. Such information may optionally be included in a periodic report and/or may also optionally be sent to the third party after each such purchase.

According to optional but preferred embodiments of the present invention, in order to facilitate supervision of the purchase process by the third party while simultaneously affording greater freedom to the user, the system of the present invention optionally and more preferably features a filtering software program. The filtering software program could for example be a “nanny software program”, such as Net Nanny™ (available from SysCon Technology Inc., La Mirada, Calif., USA). These software programs are triggered by the presence of an inappropriate word and/or phrase in the domain name and/or Web page of a vendor. Such a filtering software program could optionally be used as part of the set of rules, in order to prevent the user from performing any purchases at a vendor with a Web site that violates the rule(s) of the filtering software program, which could be particularly useful for preventing access of minor children to inappropriate Web sites such as pornographic Web sites for example. However, preferably such a filtering function would be limited in operation to blocking purchases. Also, alternatively, the parent or guardian of a minor, or another third party, could more closely monitor and control each purchase by requiring approval of each purchase before it is made, thus overcoming this problem through the method of the present invention.

While the invention has been described with respect to a limited number of embodiments, it will be appreciated that many variations, modifications and other applications of the invention may be made.

What is claimed is:

1. A method for performing a plurality of e-commerce activities by a user to a plurality of vendors through a network, the method comprising the steps of:
(a) providing a single unified interface for interacting with the user;
(b) selecting a first e-commerce activity by the user;
(c) retrieving information from each of the plurality of vendors by said single unified interface through the network about said first e-commerce activity to form retrieved information;
(d) selecting a product by the user according to said retrieved information; and
(e) purchasing said product by the user through said single unified interface.

2. The method of claim 1, wherein said first e-commerce activity is a price comparison activity, such that step (b) includes the step of selecting a product by the user, and (c) includes the steps of:
(i) requesting a price for said product by said single unified interface to each vendor through the network;
(ii) receiving said price from each vendor; and
(iii) comparing each price from each vendor.

3. The method of claim 2, wherein a name and link to a vendor having the lowest price is displayed by said single unified interface.

4. The method of claim 3, wherein step (e) is performed by purchasing said product from said vendor having the lowest price.

5. The method of claim 3, wherein step (c) further includes the step of:
(iv) selecting a Web page of said vendor for describing said product through said link; and
(v) displaying said Web page.

6. The method of claim 5, wherein step (v) is performed by said single unified interface.

7. The method of claim 5, wherein step (v) further comprises the steps of:
(1) providing a Web browser for communicating with said single unified interface; and
(2) displaying said Web page by said Web browser.

8. The method of claim 1, further comprising the step of:
(f) viewing an account of purchases by the user.

9. The method of claim 1, further comprising the step of:
(g) storing at least one significant e-commerce related date by said single unified interface; and
(h) reminding the user of said at least one date before said at least one date has arrived.

10. The method of claim 9, wherein said at least one date is for purchasing a gift by the user.

11. The method of claim 1, wherein step (b) further comprises the step of entering search information by the user, such that step (c) includes the step of performing a search by sending a request containing said search information to each of said plurality of vendors by said single unified interface.

12. The method of claim 11, wherein step (d) includes the step of displaying search results to the user by said single unified interface and step (c) further comprises the step of performing a price comparison search with at least one product from said search results.

13. The method of claim 1, wherein step (e) includes the step of entering credit card information by the user.

14. The method of claim 13, wherein step (e) further includes the step of entering shipping information by the user.

15. The method of claim 14, further comprising the steps of:
(f) storing said credit card information and said shipping information to form stored e-commerce information; and
(g) performing a second purchase by the user with said stored e-commerce information.

16. The method of claim 15, wherein step (a) further comprises the step of providing a computational device for operating said single unified interface, said computational device being local to the user, such that step (f) is performed by storing said e-commerce information on said computational device.

17. The method of claim 16, wherein the network is the Internet, such that said computational device is connected to the Internet.

18. The method of claim 1, wherein a third party has at least partial control of the plurality of e-commerce activities, and wherein step (e) includes the steps of:
(i) providing at least one rule by said third party for controlling the plurality of e-commerce activities;
(ii) comparing at least one characteristic of said first e-commerce activity to said at least one rule; and
(iii) if said at least one characteristic of said first e-commerce activity complies with said at least one rule, permitting said product to be purchased.

19. The method of claim 18, wherein said at least one rule is selected from the group consisting of performing purchases only at a list of permitted vendors; not performing purchases at a list of forbidden vendors; limiting a single purchase at a vendor to an amount of money; limiting an amount for a single item to an amount of money; limiting a total amount of money spent over a period of time; permitting or forbidding “carry over” if any limit is not exceeded; and limiting a shipping address for receiving a product to at least one address.

20. The method of claim 18, wherein said at least one rule requires confirmation for purchasing said product by said third party, such that step (ii) includes the step of waiting for said confirmation from said third party, such that step (iii) is only performed if said confirmation is received.

21. The method of claim 20, wherein said confirmation is performed by manual confirmation by said third party.

22. The method of claim 18, further comprising the step of:
(f) sending a receipt to said third party, said receipt including details about purchasing said product.

23. A method for controlling an e-commerce activity of a user to a vendor through a network by a third party, the method comprising the steps of:
(a) providing a single unified interface for interacting with the user and providing at least one rule by said third party for controlling the plurality of e-commerce activities;
(b) selecting the e-commerce activity by the user;
(c) retrieving information from the vendor by said single unified interface through the network about the e-commerce activity to form retrieved information;
(d) selecting a product by the user according to said retrieved information;
(e) comparing at least one characteristic of the e-commerce activity to said at least one rule; and
(f) if said at least one characteristic of said first e-commerce activity complies with said at least one rule, purchasing said product by the user through said single unified interface.

24. A system for performing a plurality of e-commerce activities by a user through a network, the system comprising:
(a) a user computational device for being local to the user, said user computational device being connected to the network;
(b) a single unified interface for being operated by said user computational device and for interacting with the user;
(c) a plurality of vendors connected to the network; and
(d) an integrated server for communicating with said single unified interface to receive a request for performing a plurality of e-commerce activities, and for communicating with said plurality of vendors to perform said plurality of e-commerce activities; ps wherein at least one e-commerce activity includes displaying information about a previous e-commerce activity, said information being stored on said user computational device.

25. The system of claim 24, wherein said integrated server compares at least one characteristic of said at least one e-commerce activity to a rule, such that said at least one e-commerce is performed only if said at least one characteristic complies with said rule.
